(19) United States
(12) Patent Application Publication
(10) Pub. No.: US 2021/0110497 A1
(43) Pub. Date: Apr. 15, 2021

(54) PEER-TO-PEER SCHOLARSHIP, MENTORSHIP, AND APPRENTICESHIP DISTRIBUTED APPLICATION, METHOD, AND SYSTEM USING A BLOCKCHAIN

(71) Applicant: Micah McCrary-Dennis, Beaverton, OR (US)

(72) Inventor: Micah McCrary-Dennis, Beaverton, OR (US)

(21) Appl. No.: 17/129,894

(22) Filed: Dec. 21, 2020

Related U.S. Application Data
(63) Continuation of application No. 16/190,673, filed on Nov. 14, 2018.

(51) Int. Cl. G06Q 50/20; G06F 16/23; G09B 5/08; G06Q 20/22; G06Q 20/06; G06F 16/27

(52) U.S. Cl. CPC G06Q 50/2053; G06F 16/2372; G06F 16/27; G06Q 20/29; G06Q 20/065; G09B 5/08

(57) ABSTRACT

A blockchain configuration may provide a simple and secure infrastructure for students to identify subject matter experts as tutors and career mentors, as well as earn scholarship funds in the form of microtransactions of digital currency. One example method may comprise one or more of transmitting a query to a network of devices to respond in exchange for a microtransaction reward of digital currency; receiving a plurality of responses from the network of devices; determining one or more best responses from among the plurality of responses; transmitting the reward to the one or more devices that provided the one or more best responses; combining data related to the query, responses, best answers, and microtransactions into a block of data; and recording the block of data on a blockchain. The method may also include validating the query and plurality of responses in exchange for a microtransaction according to a blockchain proof-of-work configuration.

### CROSS-REFERENCE TO RELATED APPLICATIONS

This is a continuation application of non-provisional patent application Ser. No. 16/190,673, Peer-To-Peer Scholarship, Mentorship, and Apprenticeship Distributed Application, Method, and System Using a Blockchain, filed by McCrary-Dennis on Nov. 14, 2018.

### TECHNICAL FIELD

This application relates to providing technology-assisted educational tools and financial assistance, and more specifically to providing real-time, peer-to-peer educational mentorship and scholarships using a blockchain.

### BACKGROUND

Mentorship of students ranges from in-person tutoring to Internet-based educational tools, with the latter providing more flexibility for students to learn and practice new skills without the restrictions of scheduling in-person meetings with tutors that live and work physically nearby. Similarly, the process for students to apply for and obtain financial scholarships to fund their education has evolved from a purely in-person, paper-based system to an Internet-based model allowing students to compete for a wider range of available scholarships from nationwide and worldwide donors. With ever-increasing competition for limited placement in top-tier high schools and colleges, as well as the rising costs of secondary and collegiate education, it is more crucial than ever that students have immediate access to effective educational mentorship and scholarship funding. The subject matter of this patent application provides an even more effective, comprehensive, and immediate solution to the mentorship, apprenticeship, and scholarship needs of today's and tomorrow's students by leveraging a blockchain's advantages as a public, open-source, tamperproof, and universal ledger. Specifically, the claimed invention allows students to crowdsource solutions to their homework and career questions to blockchain-verified experts, mentors, peers, and potential employers and donors, while crowdfunding scholarship funds in real-time in the form of microtransactions awarded for asking those questions.

### SUMMARY

One example embodiment may include a method that comprises a blockchain-based distributed application that may provide a simple and secure infrastructure for mentorship, apprenticeship, and scholarship applications. One example method of operation may comprise one or more of transmitting a mentorship or apprenticeship request to a network of authenticated experts to answer a question or solve a problem associated with a homework assignment or career counseling, receiving results based on the question or problem, determining the best response among the received responses, and recording the results in a blockchain. The method may also include one or more of a reward accompanying the mentorship or apprenticeship request; the reward being transferred to the source of the response determined to be the best response, whether the source is a human or computer; a scholarship in the form of a microtransaction being transferred to the source of the request to positively reinforce students that ask good questions and incentivize students to ask good questions in the future; and recording the transactions in a blockchain.

Another example embodiment may include an apparatus that comprises one or more of a transmitter configured to transmit a mentorship or apprenticeship request to a network of authenticated experts to answer a question or solve a problem associated with a homework assignment or career counseling, and transmit a reward to one or more experts or peers that provide a response or responses determined to be the best response; a receiver configured to receive answers or solutions, and receive scholarships in the form of microtransactions, based on the question or problem; and a processor configured to accept user input identifying the best response, and record the answers, solutions, and transactions in a blockchain.

Still another example embodiment may include a non-transitory computer readable storage medium configured to store instructions that when executed causes a processor to perform one or more of: transmitting a mentorship or apprenticeship request to a network of authenticated experts to answer a question or solve a problem associated with a homework assignment or career counseling, receiving responses based on the question or problem, determining the best response among the received responses, and recording the results in a blockchain.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a schematic diagram of an example blockchain system configuration according to example embodiments.

FIG. 2 illustrates a flow diagram of a peer-to-peer mentorship, apprenticeship, and scholarship blockchain configuration according to example embodiments.

FIG. 3 illustrates a flow diagram of a peer-to-peer mentorship, apprenticeship, and scholarship blockchain configuration according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium, and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

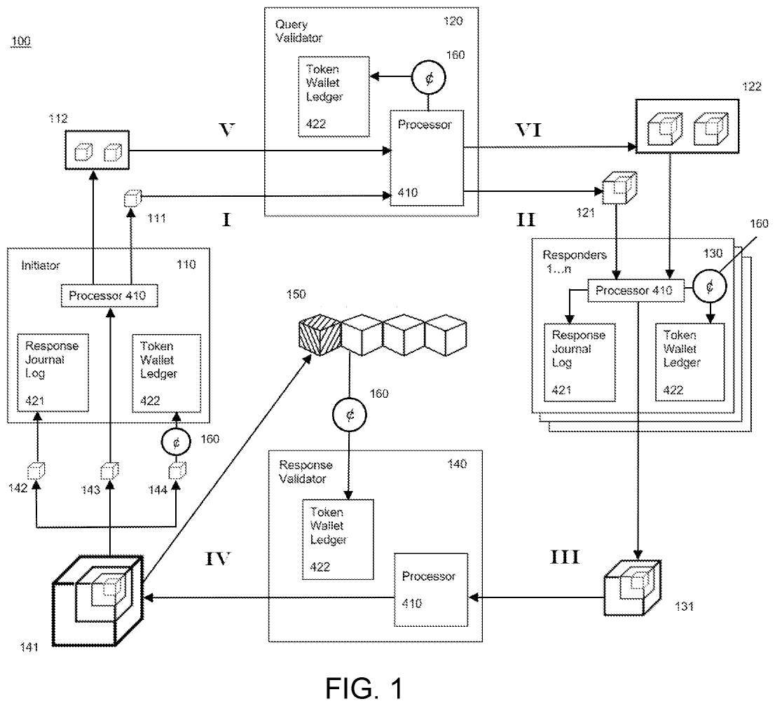

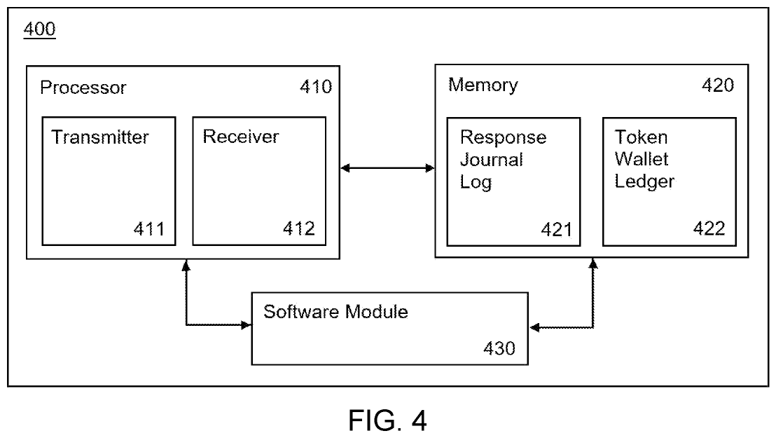

FIG. 1 illustrates a schematic diagram of a peer-to-peer mentorship, apprenticeship, and scholarship blockchain system configuration according to example embodiments. Referring to FIG. 1, the system 100 used to transmit and receive data requests and microtransactions 160 may include an initiator node 110, a query validator 120, a plurality of responder nodes 130, a response validator node 140, and a blockchain 160. As explained in FIG. 4, each node may be a network entity 400 consisting of one or more of a processor 410, a response journal log 421, a token wallet ledger 422, and a software module 430, which, for the sake of space and simplicity, is not shown in FIG. 1. The nodes may interact as part of a peer-to-peer network configured to transmit and receive data digitally by any suitable method known in the art, such as, e.g., using a network such as the Internet to access an interface such as a distributed application.

Initiator node 110, such as, e.g., a student, may transmit a request, such as, e.g., a broadcast transaction query 111 to a plurality of responder nodes 130, such as, e.g., experts, mentors, or peers, whose credentials may be stored on the blockchain to foster confidence in their expertise, that may send responses packaged with the initial request back to initiator node 110 and record the complete package of data, and associated microtransactions 160, as a block on a blockchain 150. Broadcast transaction query 111 may contain one or more of a question to answer, a problem to solve, a reward offer for responding to the request, and a time limit. In one embodiment, the amount of the reward offer may increase in proportion to the urgency of the request. Broadcast transaction query 111 may be in any suitable form known in the art, such as, e.g., one or more of text, digital images, audio files, a mathematical equation, a puzzle, a game, or computer code.

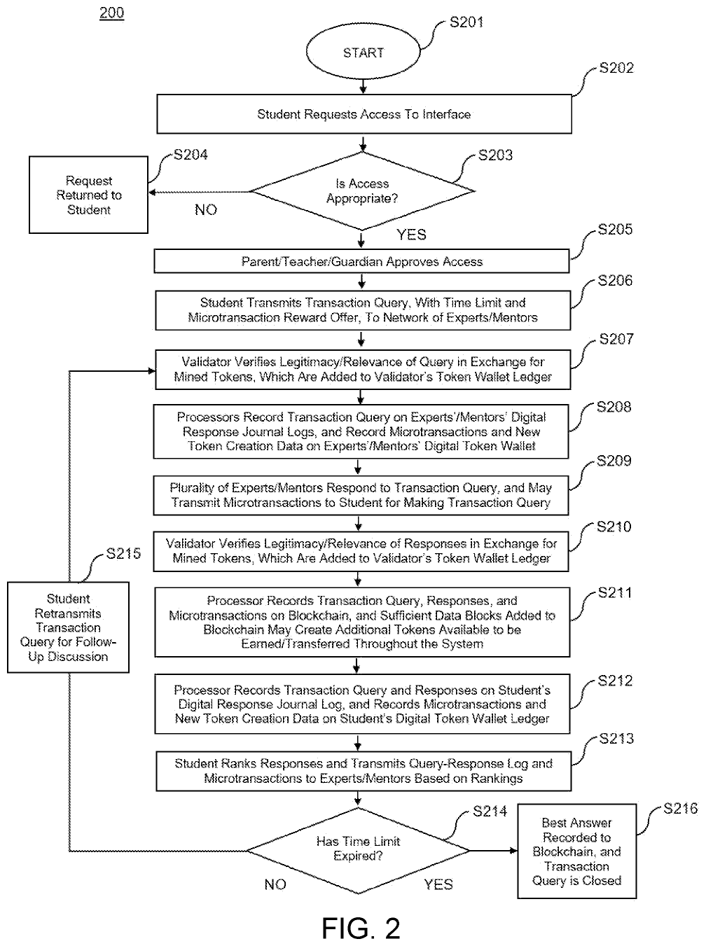

In one embodiment, initiator node 110 may transmit broadcast transaction query 111 to a plurality of responder nodes 130, one of which may act as a query validator node 120, as shown in section I of FIG. 1, to verify the legitimacy or relevance of the request based on predetermined criteria, as explained in FIG. 2. A processor 410 may receive the request, verify the request, and earn or “mine” digital currency as a microtransaction 160, which is recorded on a token wallet ledger 422 on query validator node 120, in exchange for verifying the request. Microtransaction 160 may be a transaction of digital currency, which may be authorized upon completion of one or more predetermined tasks. In one embodiment, the one or more tasks may be monitored for fulfillment, and the transaction approved for completion, by any suitable method known in the art, such as, e.g., a smart contract.

As shown in section II of FIG. 1, processor 410 of query validator node 120 may then append data related to the validation of the request to the broadcast transaction query 111 to create a package of query and validation data 121, which processor 410 transmits to a plurality of responder nodes 130. Processor 410 of each responder node 130 records the request portion of package of query and validation data 121 response journal log 421 of responder node 130 and records data about all microtransactions 160 in system 100 to token wallet ledger 422 of responder node 130. Responses by responder nodes 130 may be in any suitable form known in the art, such as, e.g., in the form of one or more of text, digital images, or audio files; a final or step-by-step solution to a mathematical equation; a completed puzzle; a game played between the responder and initiator in any suitable manner known in the art, such as, e.g., a turn-based or real-time interaction; or edited computer code. Processors 410 append the plurality of responses to package of query and validation data 121 to create a package of query, validation, and response data 131, which, as shown in section III of FIG. 1, is verified by a response validator node 140.

Similar to query validator node 120, response validator node 140 verifies the legitimacy or relevance of the plurality of responses in exchange for a microtransaction 160 of earned or “mined” tokens. In one embodiment, processor 410 of response validator node 140 appends validation data to package of query, response, and validation data 131 to create a package of query, response, and dual validation data 141, which is added as a complete block of data to blockchain 150, as shown in section IV of FIG. 1. In exchange, response validator node 140 earns or “mines” tokens, which are recorded on token wallet ledger 422 of response validator node 140.

Also shown in section IV, package of query, response, and dual validation data 141 is transmitted to initiator node 110, where processor 410 of initiator node 110 combines data from package of query, response, and dual validation data 131 related to the query and plurality of responses to create a log block 142, which is recorded in response journal log 421 of initiator node 110. Similarly, processor 410 of initiator node 110 combines data related to microtransactions 160 related to the request, along with an open-source history of all token microtransactions 160 on system 100, to create a ledger block 144, which is recorded in token ledger wallet 422 of initiator node 110. The open-source history of all microtransactions 160 may include data related to the creation, use, turnover, and destruction of tokens, which may support the transparency, integrity, anonymity, and immutability of microtransactions 160, as well as prevent issues of “double spend” of tokens on system 100.

In another embodiment, processor 410 of initiator node 110 combines data related to citations used as factual bases for the plurality of responses to create reference blocks 143. In one embodiment, reference blocks 143 may be timestamped visual access points to copies of the references, such as, e.g., digital articles or databases, cited by responder nodes 130 in responding to the request. As shown in sections V of FIG. 1, a plurality 112 of reference blocks 143 including the visual access points may be transmitted for verification to query validator node 120, after which a plurality of validated reference blocks 122 is transmitted to the plurality of responder nodes 130 during subsequent iterations of the method, or accompanying final microtransactions 160 related to the request. In still another embodiment, reference blocks 143 may be individualized and include personalized messages between initiator node 110 and respective responder nodes 130, e.g., so that a student and expert may continue their discussion of the subject matter, industry, or the student's career goals during the iterations of the request, with the possibility of a establishing a long-term mentorship or apprenticeship relationship.

In another embodiment, initiator node 110 ranks the plurality of responses by any suitable method known in the art, such as, e.g., by using an interface to “click” on a “best response” to indicate a “like” or other approval of the best answer or answers, or assigning a numerical rating to responses. In one embodiment, data related to which answer or answers were identified as the “best answers” may be appended to reference blocks 143, which may be personalized and then transmitted to respective responder nodes 130, as described above for sections V and VI of FIG. 1. In yet another embodiment, authorized rewards of microtransactions 160 may also be appended to reference blocks 143, which may then be transmitted to respective responder nodes 130, as described above for sections V and VI of FIG. 1.

FIG. 2 illustrates a flow diagram of an example method of operation according to example embodiments. In step S201, the method starts. In step S202, an initiator node 110, such as, e.g., a student, may request an authorizing party, such as, e.g., a parent, teacher, or guardian, to grant access to the peer-to-peer mentorship, apprenticeship, and scholarship system 100, which may be in any suitable form, such as, e.g., a distributed application or other interface. In step S203, the authorizing party may determine if the access request is appropriate based on any suitable criteria known in the art, such as, e.g., whether the question relates to an appropriate subject, whether the request is deliberately vulgar, offensive, or provocative, or whether it involves behavior that is commonly known as “trolling.” If the access request is not appropriate, then the method proceeds to step S204, where the request is returned unfulfilled to the initiator node 110, and the method terminates. In one embodiment, the request may be returned with an explanation of why it was not fulfilled, and where applicable, be accompanied by penalties or warnings of penalties for future inappropriate requests, such as, e.g., revoked access to the system 100. If the access request is appropriate, then the method proceeds to step S205, where the authorizing party approves the initiator node 110 to access the system 100, and then the method proceeds to step S206.

In step S206, the initiator node 110 transmits a request, such as, e.g., a broadcast transaction query 111 to a network of responder nodes 130, such as, e.g., experts on the associated subject matter or mentors in the related field or industry. In one embodiment, the experts or mentors may be connected to system 100 in any suitable form, such as, e.g., as a network of nodes or other network entities 400, as described in FIG. 4, that may access an interface or distributed application of system 100, and the plurality of responder nodes 130 may be humans, computers, or other intelligent entities. Broadcast transaction query 111 may contain one or more of a question to answer, a problem to solve, a reward offer for responding to the request, and a time limit. Broadcast transaction query 111, or the question or problem thereof, may be in any suitable form known in the art, such as, e.g., one or more of text, digital images, audio files, a mathematical equation, a puzzle, a game, or computer code.

The reward may be in any suitable form, such as, e.g., a pending transaction of digital currency, including a microtransaction 160 of digital currency, which may be authorized upon completion of one or more predetermined tasks. In one embodiment, the one or more tasks may be monitored for fulfillment, and the microtransaction 160 approved for processing, by any suitable method known in the art, such as, e.g., a smart contract, that is, computer code that operates to enforce or administer the agreed-upon terms of an agreement or transaction. Transmitting broadcast transaction query 111 may include using a distributed peer proxy node server to distribute broadcast transaction query 111 to a plurality of distributed peer proxy node client devices operating as the network of nodes, such as, e.g., responder nodes 130 associated a plurality of experts or mentors. The method then proceeds to step S207.

In step S207, a query validator node 120 may verify the legitimacy or relevance of broadcast transaction query 111 based on any suitable criteria known in the art, such as, e.g., whether the request may logically be fulfilled, whether the amount of the microtransaction 160 associated with the reward offer is within allowed limits, or whether, as a secondary check, the request is appropriate based on the criteria explained in step S203, above. In one embodiment, query validator node 120 is the first-in-time from among a pool of the potential responder nodes 130 that successfully verifies broadcast transaction request 111. In another embodiment, verification of broadcast transaction query 111 may be accomplished by an algorithm. In yet another embodiment, query validator node 120 may earn a bonus for verifying the legitimacy or relevance of broadcast transaction query 111, such as, e.g., query validator node 120 may be awarded a microtransaction 160 of digital tokens or other value from a blockchain 150, or broadcast transaction query 111 itself may authorize a microtransaction 160 of digital currency to transfer from a digital currency account of initiator node 110 to a digital currency account of query validator node 120 by any suitable manner known in the art, such as, e.g., by using a smart contract.

Alternatively, the bonus may involve allowing query validator node 120 to “mine” tokens or other digital units of value from a blockchain 150 associated with system 100, based on a “proof-of-work” blockchain system, that may be used for future microtransactions 160 of value within or outside of system 100, such as, e.g., to reward other users of system 100, or to be exchanged for fiat currency outside of system 100. In another embodiment, the value of the digital tokens may be based on a “proof-of-stake” blockchain system, where a user may gain benefits or status inside or outside of system 100 proportional to the amount of tokens the user owns, such as, e.g., higher rankings as an expert in a subject matter, or the ability to offer, transfer, or receive larger microtransaction amounts. In yet another embodiment, system 100, or an interface or distributed application thereof, may combine features of the “proof-of-work” and “proof-of-stake” blockchain systems described above.

Transaction data related to transfers of tokens or other digital values may be recorded on a token wallet ledger 422 or another digital ledger of query validator node 120. Validation data may then be appended to broadcast transaction query 111 to create a combined package of query and validation data 121, which is transmitted by a processor 410 of query validator node 120 to a plurality of responder nodes 130, and the method then proceeds to step S208. In the event that broadcast transaction query 111 is not verified, query validator node 120 may return the request to initiator node 110 so that initiator node 110 may amend and retransmit the request.

In step S208, processors 410 on responder nodes 130 may record broadcast transaction query 111 on digital response journal logs 421 of respective responder nodes 130. Similarly, processors 410 may record data related to digital currency transactions, including the creation of new tokens on a blockchain 150 associated with system 100, on digital token wallet ledgers 422 of respective responder nodes 130. The method then proceeds to step S209.

In step S209, plurality of responder nodes 130 associated with experts or mentors may respond to broadcast transaction query 111. The experts or mentors associated with plurality of responder nodes 130 may respond to the request in any suitable manner known in the art, such as, e.g., by transmitting responses in the form of one or more of text, digital images, or audio files; a final or step-by-step solution to a mathematical equation; a solved puzzle; a game played between the responder and initiator in any suitable manner known in the art, such as, e.g., a turn-based or real-time interaction; or edited computer code. Processors 410 of respective responder nodes 130 may append the plurality of responses to package of query and validation data 121 to create a package of query, validation, and response data 131, which may then be transmitted back to initiator node 110 after validation by a response validator node 140.

In one embodiment, experts or mentors associated with the plurality of responder nodes 130 may transmit microtransactions 160 to initiator node 110, for example, to reward a student for submitting the request, to incentivize students to send high quality requests in the future, or to provide scholarship funding in the form of microtransactions 160 of digital currency, which may be exchanged for fiat currency, such as, e.g., United States Dollars. In this embodiment, microtransaction data is also appended to the package of query, validation, and response data 131, which together is transmitted back to initiator node 110 after validation by a response validator node 140. The method then proceeds to step S210.

In step S210, response validator node 140 may verify the legitimacy or relevance of the plurality of responses received from responder nodes 130 based on any suitable criteria known in the art, such as, e.g., whether the content of the responses is pertinent to the request, whether a response is abusive or otherwise inappropriate, or whether the amount of a microtransaction 160 is within allowed limits, similar to the criteria explained in step S207. In one embodiment, response validator node 140 is the first-in-time from among a pool of the potential responder nodes 130 that successfully verifies package of query, validation, and response data 131. In another embodiment, verification of the plurality of responses may be accomplished by an algorithm. In yet another embodiment, response validator node 140 may earn a bonus for verifying the legitimacy or relevance of package of query, validation, and response data 131, such as, e.g., response validator node 140 may be awarded a microtransaction 160 of digital tokens or other value from a blockchain 150, or package of query, validation, and response data 131 itself may authorize a microtransaction 160 of digital currency to transfer from a digital currency account of initiator node 110 to a digital currency account of response validator node 140 by any suitable manner known in the art, such as, e.g., by using a smart contract.

Alternatively, the bonus may involve allowing response validator node 140 to “mine” tokens or other digital units of value from a blockchain 150 associated with system 100, based on a “proof-of-work” blockchain system, that may be used for future microtransactions 160 of value within or outside of system 100, such as, e.g., to reward other users of system 100, or to be exchanged for fiat currency outside of system 100. In another embodiment, the value of the digital tokens may be based on a “proof-of-stake” blockchain system, where a user may gain benefits or status inside or outside of system 100 proportional to the amount of tokens the user owns, such as, e.g., higher rankings as an expert in a subject matter, or the ability to offer, transfer, or receive larger microtransaction amounts. In yet another embodiment, system 100, or an interface or distributed application thereof, may combine features of the “proof-of-work” and “proof-of-stake” blockchain systems described above.

Transaction data related to transfers of tokens or other digital values may be recorded on a token wallet ledger 422 or another digital ledger of response validator node 120. Validation data may then be appended to package of query, validation, and response data 131 to create a combined package of query, response, and dual validation data 141, and the method then proceeds to step S211. In the event that package of query, response, and dual validation data 131 is not verified, response validator node 140 may return the unverified responses to respective responder nodes 130 so that responder nodes 130 may amend and retransmit the responses during subsequent iterations, if any, of the method before expiration of the time limit.

In step S211, processor 410 of response validator node 140 records package of query, response, and dual validation data 131 as a complete block on blockchain 150 associated with system 100, and transmits package of query, response, and dual validation data 131 to initiator node 110. Sufficient blocks of data added to blockchain 150 may create new tokens or other digital units of value, which may then be available for mining by other network entities 400 in the future, and a microtransaction 160 of tokens may be transmitted to response validator node 140 of the current block of data and recorded on digital token wallet ledger 422 of response validator node 140. The method then proceeds to step S212.

In step S212, processor 410 of initiator node 110 receives and records package of query, response, dual validation data 131. In one embodiment, processor 410 of initiator node 110 combines data from package of query, response, and dual validation data 131 related to the query and plurality of responses to create a log block 142, which is recorded in response journal log 421 of initiator node 110. Similarly, processor 410 of initiator node 110 combines data related to microtransactions 160 related to the request, along with an open-source history of all token microtransactions 160 on system 100, to create a ledger block 144, which is recorded in token ledger wallet 422 of initiator node 110. The open-source history of all microtransactions 160 may include data related to the creation, use, turnover, and destruction of tokens, which may support the transparency, integrity, anonymity, and immutability of microtransactions 160, as well as prevent issues of “double spend” of tokens on system 100.

In yet another embodiment, processor 410 of initiator node 110 combines data related to citations used as factual bases for the plurality of responses to create reference blocks 143. In one embodiment, reference blocks 143 may be timestamped visual access points to copies of the references, such as, e.g., digital articles or databases, cited by responder nodes 130 in responding to the request. The visual access points may be transmitted to the plurality of responder nodes 130 during subsequent iterations of the method or accompanying final microtransactions 160 related to the request. In still another embodiment, reference blocks 143 may be individualized and include personalized messages between initiator node 110 and respective responder nodes 130, e.g., so that a student and expert may continue their discussion of the subject matter, industry, or the student's career goals during the iterations of the request, with the possibility of a establishing a long-term mentorship or apprenticeship relationship. The method then proceeds to step S213.

In step S213, initiator node 110 ranks the plurality of responses by any suitable method known in the art, such as, e.g., by using an interface to “click” on a “best response” to indicate a “like” or other approval of the best answer or answers, or assigning a numerical rating to responses. In one embodiment, data related to which answer or answers were identified as the “best answers” may be appended to reference blocks 143, which may be personalized and then transmitted to respective responder nodes 130. In yet another embodiment, authorized rewards of microtransactions 160 may also be appended to reference blocks 143, which may then be transmitted to respective responder nodes 130. The method then proceeds to step S214.

In step S214, processor 410 of initiator node 110 may determine whether the time limit included in broadcast transaction query 111 has expired. If so, the method proceeds to step S216. If not, the method proceeds to step S215, where reference blocks 143 are resubmitted to the plurality of responder nodes 130 for further discussion, and steps S207, S208, S209, S210, S211, S212, S13, and S214 are essentially repeated to collect additional data and microtransactions 160, until the time limit eventually expires.

In step S216, one or more best answers, as determined by initiator node 110, along with the complete block of data related to the request and responses, are recorded on blockchain 150 where they are publicly available, and broadcast transaction query 111 is closed. In one embodiment, all outstanding approved microtransaction 160 transmissions are completed before the request is closed.

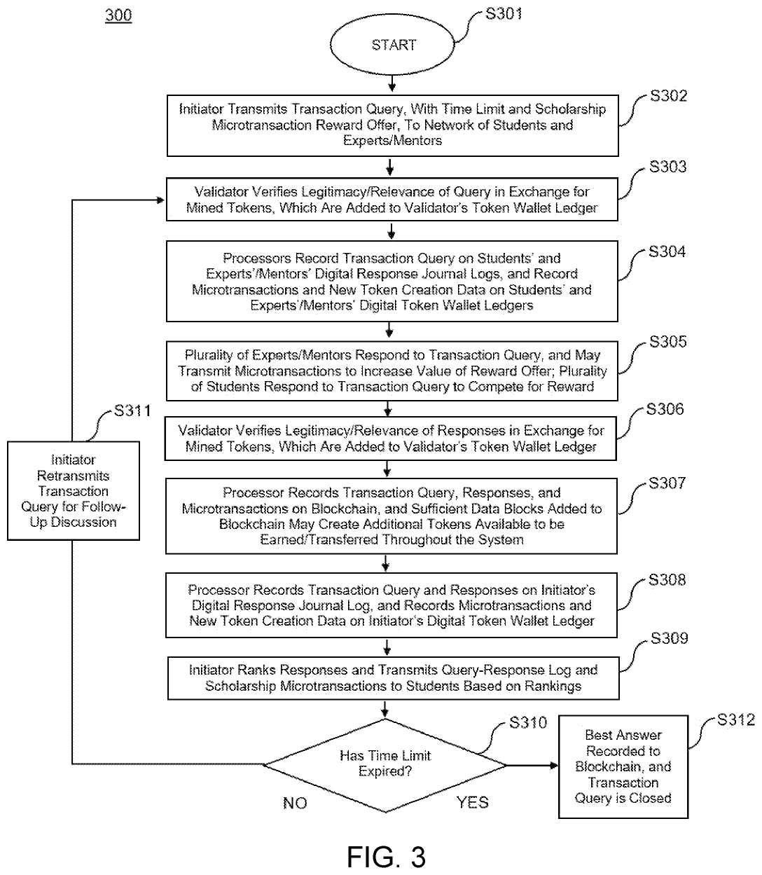

FIG. 3 illustrates a flow diagram of an example method of operation according to example embodiments. In step S301, the method starts. In step S302, an initiator node 110, such as, e.g., an expert, mentor, or scholarship donor, transmits a request, such as, e.g., a broadcast transaction query 111 to a network of responder nodes 130, such as, e.g., students studying or interested in the subject matter that may compete for scholarship microtransactions 160, or other experts, mentors, or scholarship donors that may contribute expertise to the discussion or provide scholarship microtransactions 160. In one embodiment, students may be connected to system 100 in any suitable form, such as, e.g., as a network of nodes or other network entities 400, as described in FIG. 4, that may access an interface or distributed application of system 100, and the plurality of responder nodes 130 may be individual students, groups of students, or research entities. Broadcast transaction query 111 may contain one or more of a question to answer, a problem to solve, a scholarship reward offer for responding to the request, and a time limit. Broadcast transaction query 111, or the question or problem thereof, may be in any suitable form known in the art, such as, e.g., one or more of text, digital images, audio files, a mathematical equation, a puzzle, a game, or computer code.

The scholarship reward may be in any suitable form, such as, e.g., a pending transaction of digital currency, including a microtransaction 160 of digital currency, which may be authorized upon completion of one or more predetermined tasks. In one embodiment, the one or more tasks may be monitored for fulfillment, and the microtransaction 160 approved for processing, by any suitable method known in the art, such as, e.g., a smart contract, that is, computer code that operates to enforce or administer the agreed-upon terms of an agreement or transaction. Transmitting broadcast transaction query 111 may include using a distributed peer proxy node server to distribute broadcast transaction query 111 to a plurality of distributed peer proxy node client devices operating as the network of nodes, such as, e.g., responder nodes 130 associated a plurality of experts or mentors. The method then proceeds to step S303.

In step S303, a query validator node 120 may verify the legitimacy or relevance of broadcast transaction query 111 based on any suitable criteria known in the art, such as, e.g., whether the request may logically be fulfilled, or whether the amount of the microtransaction 160 associated with the scholarship reward offer is within allowed limits. In one embodiment, query validator node 120 is the first-in-time from among a pool of the potential responder nodes 130 that successfully verifies broadcast transaction request 111. In another embodiment, verification of broadcast transaction query 111 may be accomplished by an algorithm. In yet another embodiment, query validator node 120 may earn a bonus for verifying the legitimacy or relevance of broadcast transaction query 111, such as, e.g., query validator node 120 may be awarded a microtransaction 160 of digital tokens or other value from a blockchain 150, or broadcast transaction query 111 itself may authorize a microtransaction 160 of digital currency to transfer from a digital currency account of initiator node 110 to a digital currency account of query validator node 120 by any suitable manner known in the art, such as, e.g., by using a smart contract.

Alternatively, the bonus may involve allowing query validator node 120 to “mine” tokens or other digital units of value from a blockchain 150 associated with system 100, based on a “proof-of-work” blockchain system, that may be used for future microtransactions 160 of value within or outside of system 100, such as, e.g., to reward other users of system 100, or to be exchanged for fiat currency outside of system 100. In another embodiment, the value of the digital tokens may be based on a “proof-of-stake” blockchain system, where a user may gain benefits or status inside or outside of system 100 proportional to the amount of tokens the user owns, such as, e.g., higher rankings as an expert in a subject matter, or the ability to offer, transfer, or receive larger microtransaction amounts. In yet another embodiment, system 100, or an interface or distributed application thereof, may combine features of the “proof-of-work” and “proof-of-stake” blockchain systems described above.

Transaction data related to transfers of tokens or other digital values may be recorded on a token wallet ledger 422 or another digital ledger of query validator node 120. Validation data may then be appended to broadcast transaction query 111 to create a combined package of query and validation data 121, which is transmitted by a processor 410 of query validator node 120 to a plurality of responder nodes 130, and the method then proceeds to step S304. In the event that broadcast transaction query 111 is not verified, query validator node 120 may return the request to initiator node 110 so that initiator node 110 may amend and retransmit the request.

In step S304, processors 410 on responder nodes 130 may record broadcast transaction query 111 on digital response journal logs 421 of respective responder nodes 130. Similarly, processors 410 may record data related to digital currency transactions, including the creation of new tokens on a blockchain 150 associated with system 100, on digital token wallet ledgers 422 of respective responder nodes 130. The method then proceeds to step S305.

In step S305, plurality of responder nodes 130 associated with students, experts, mentors, peers, or donors may respond to broadcast transaction query 111. The students associated with plurality of responder nodes 130 may respond to the request in any suitable manner known in the art, such as, e.g., by transmitting responses in the form of one or more of text, digital images, or audio files; a final or step-by-step solution to a mathematical equation; a solved puzzle; a game played between the responder and initiator in any suitable manner known in the art, such as, e.g., a turn-based or real-time interaction; or edited computer code.

In another embodiment, experts, mentors, or donors associated with plurality of responder nodes 130 may respond to the request by providing clues to students attempting to respond to the request, authorize microtransactions 160 to increase the amount of the scholarship reward to the eventual best responder, or provide direct scholarship funding in the form of microtransactions 160 of digital currency to encourage students as they work to solve the problem presented in the request. In yet another embodiment, experts, mentors, or donors may make offers for initiator node 110 to match scholarship microtransaction awards, which may increase the amount of direct or overall scholarship microtransactions 160. Processors 410 of respective responder nodes 130 may append the plurality of responses to package of query and validation data 121 to create a package of query, validation, and response data 131, which may then be transmitted back to initiator node 110 after validation by a response validator node 140. The method then proceeds to step S306.

In step S306, response validator node 140 may verify the legitimacy or relevance of the plurality of responses received from responder nodes 130 based on any suitable criteria known in the art, such as, e.g., whether the content of the responses is pertinent to the request, whether a response is abusive or otherwise inappropriate, or whether the amount of a microtransaction 160 is within allowed limits, similar to the criteria explained in step S303. In one embodiment, response validator node 140 is the first-in-time from among a pool of the potential responder nodes 130 that successfully verifies package of query, validation, and response data 131. In another embodiment, verification of the plurality of responses may be accomplished by an algorithm. In yet another embodiment, response validator node 140 may earn a bonus for verifying the legitimacy or relevance of package of query, validation, and response data 131, such as, e.g., response validator node 140 may be awarded a microtransaction 160 of digital tokens or other value from a blockchain 150, or package of query, validation, and response data 131 itself may authorize a microtransaction 160 of digital currency to transfer from a digital currency account of initiator node 110 to a digital currency account of response validator node 140 by any suitable manner known in the art, such as, e.g., by using a smart contract.

Alternatively, the bonus may involve allowing response validator node 140 to “mine” tokens or other digital units of value from a blockchain 150 associated with system 100, based on a “proof-of-work” blockchain system, that may be used for future microtransactions 160 of value within or outside of system 100, such as, e.g., to reward other users of system 100, or to be exchanged for fiat currency outside of system 100. In another embodiment, the value of the digital tokens may be based on a “proof-of-stake” blockchain system, where a user may gain benefits or status inside or outside of system 100 proportional to the amount of tokens the user owns, such as, e.g., higher rankings as an expert in a subject matter, or the ability to offer, transfer, or receive larger microtransaction amounts. In yet another embodiment, system 100, or an interface or distributed application thereof, may combine features of the “proof-of-work” and “proof-of-stake” blockchain systems described above.

Transaction data related to transfers of tokens or other digital values may be recorded on a token wallet ledger 422 or another digital ledger of response validator node 120. Validation data may then be appended to package of query, validation, and response data 131 to create a combined package of query, response, and dual validation data 141, and the method then proceeds to step S307. In the event that package of query, response, and dual validation data 131 is not verified, response validator node 140 may return the unverified responses to respective responder nodes 130 so that responder nodes 130 may amend and retransmit the responses during subsequent iterations, if any, of the method before expiration of the time limit.

In step S307, processor 410 of response validator node 140 records package of query, response, and dual validation data 131 as a complete block on blockchain 150 associated with system 100, and transmits package of query, response, and dual validation data 131 to initiator node 110. Sufficient blocks of data added to blockchain 150 may create new tokens or other digital units of value, which may then be available for mining by other network entities 400 in the future, and a microtransaction 160 of tokens may be transmitted to response validator node 140 of the current block of data and recorded on digital token wallet ledger 422 of response validator node 140. The method then proceeds to step S308.

In step S308, processor 410 of initiator node 110 receives and records package of query, response, dual validation data 131. In one embodiment, processor 410 initiator node 110 combines data from package of query, response, and dual validation data 131 related to the query and plurality of responses to create a log block 142, which is recorded in response journal log 421 of initiator node 110. Similarly, processor 410 of initiator node 110 combines data related to microtransactions 160 related to the request, along with an open-source history of all token microtransactions 160 on system 100, to create a ledger block 144, which is recorded in token ledger wallet 422 of initiator node 110. The open-source history of all microtransactions 160 may include data related to the creation, use, turnover, and destruction of tokens, which may support the transparency, integrity, anonymity, and immutability of microtransactions 160, as well as prevent issues of “double spend” of tokens on system 100.

In yet another embodiment, processor 410 of initiator node 110 combines data related to citations used as factual bases for the plurality of responses to create reference blocks 143. In one embodiment, reference blocks 143 may be timestamped visual access points to copies of the references, such as, e.g., digital articles or databases, cited by responder nodes 130 in responding to the request. The visual access points may be transmitted to the plurality of responder nodes 130 during subsequent iterations of the method or accompanying final microtransactions 160 related to the request. In still another embodiment, reference blocks 143 may be individualized and include personalized messages between initiator node 110 and respective responder nodes 130, e.g., so that a student and expert may continue their discussion of the subject matter, industry, or the student's career goals during the iterations of the request, with the possibility of a establishing a long-term mentorship or apprenticeship relationship. The method then proceeds to step S309.

In step S309, initiator node 110 ranks the plurality of responses by any suitable method known in the art, such as, e.g., by using an interface to “click” on a “best response” to indicate a “like” or other approval of the best answer or answers, or assigning a numerical rating to responses. In one embodiment, data related to which answer or answers were identified as the “best answers” may be appended to reference blocks 143, which may be personalized and then transmitted to respective responder nodes 130. In yet another embodiment, authorized rewards of microtransactions 160 may also be appended to reference blocks 143, which may then be transmitted to respective responder nodes 130. The method then proceeds to step S310.

In step S310, processor 410 of initiator node 110 may determine whether the time limit included in broadcast transaction query 111 has expired. If so, the method proceeds to step S312. If not, the method proceeds to step S311, where reference blocks 143 are resubmitted to the plurality of responder nodes 130 for further discussion, and steps S303 S304, S305, S306, S307, S308, S309, and S310 are essentially repeated to collect additional data and microtransactions 160, until the time limit eventually expires. In one embodiment, initiator node 110 may honor any offers from experts, mentors, or donors to match scholarship microtransaction awards, which may increase the amount of direct or overall scholarship microtransactions 160.

In step S312, one or more best answers, as determined by initiator node 110, along with the complete block of data related to the request and responses, are recorded on blockchain 150 where they are publicly available, initiator node 110 authorizes scholarship microtransactions 160 to responder nodes 130 that provided the best responses, and broadcast transaction query 111 is closed. In one embodiment, all outstanding approved microtransaction 160 transmissions, including direct scholarship microtransactions 160 from experts, mentors, and donors to students, are completed before the request is closed.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

As illustrated in FIG. 4, a processor 410 and an exemplary storage medium or memory 420 may be discrete components of a network entity 400 that are used to execute an application or set of operations as described herein. Memory 420 may be coupled to processor 410 such that processor 410 may read information from, and write information to, memory 420. In the alternative, memory 420 may be integral to processor 410. Processor 410 and memory 420 may reside in an application specific integrated circuit (“ASIC”). In the alternative, processor 410 and memory 420 may reside as discrete components.

As described in FIGS. 1, 2, and 3, initiator node 110, query validator node 120, plurality of responder nodes 130, and response validator nodes 140 may be example embodiments of network entity 400. The application may be coded in software in a computer language understood by processor 410, and stored in a computer readable medium, such as, a memory 420 that may, for example, consist of a response journal log 421 configured to record data related to broadcast transaction queries 111 and responses, and a token wallet ledger 422 configured to record data related to microtransactions 160 and the creation of tokens as complete data blocks, composed of packages of query, response, and dual validation data 141, are added to blockchain 150. The computer readable medium may be a non-transitory computer readable medium that includes tangible hardware components, such as memory, that can store software.

Furthermore, a software module 430 may be another discrete entity that is part of the network entity 400, and which contains software instructions that may be executed by the processor 410 to effectuate one or more of the functions described herein. In addition to the above noted components of network entity 400, network entity 400 may also have a transmitter 411 and receiver 412 pair configured to receive and transmit communication signals related to data and microtransactions 160 associated with the operation of system 100, and transmitter 411 and receiver 412 may be included within processor 410.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A computer-implemented method for improving the performance of a question-and-answer network, in a transaction device, at least partially implemented in hardware, the method comprising:
transmitting, by a network interface coupled to a data communication network, a broadcast transaction request from an initiator device to a network of responder devices to answer a query within a time limit in exchange for a microtransaction reward of digital currency;
validating, with a processor, the broadcast transaction request in exchange for a microtransaction according to a blockchain proof-of-work configuration;
appending, with a processor, request validation data to the broadcast transaction request to create a package;
recording, with a processor coupled to a memory, package and microtransaction data on the plurality of responder devices;
responding, by a network interface coupled to a data communication network, to the broadcast transaction request with a plurality of responses from the network of responder devices;
appending, with a processor, the plurality of responses to the package;
validating, with a processor, the plurality of responses in exchange for a microtransaction according to a blockchain proof-of-work configuration;
appending, with a processor, response validation and microtransaction data to the package;
transmitting, by a network interface coupled to a data communication network, the package from the network of responder devices to the initiator device;
transmitting, by a network interface coupled to a data communication network, the package between the initiator device and the network of responder devices in subsequent iterations until the time limit expires;
determining, with a processor, one or more best responses from among the plurality of responses;
recording, with a processor coupled to a memory, package data and microtransactions on the initiator device;
transmitting, by a network interface coupled to a data communication network, the reward to the one or more responder devices that provided the one or more best responses;
combining, by a network interface coupled to a data communication network, data related to the request, request validation, plurality of responses, response validation, one or more best answers, and microtransactions into a block of data; and
recording, by a network interface coupled to a data communication network, the block of data on a blockchain.

2. The method of claim 1, wherein the broadcast transaction query comprises one or more of a question to answer, a problem to solve, a reward offer for responding to the request, and the time limit.

3. The method of claim 2, wherein the broadcast transaction query is in the form of one or more of text, digital images, audio files, a mathematical equation, a puzzle, a game, or computer code.

4. The method of claim 1, wherein the plurality of responses is in the form of one or more of text, digital images, audio files, a final solution to a mathematical equation, a step-by-step solution to a mathematical equation, a solved puzzle, a game played, using a network interface coupled to a data communication network, between the initiator device and one or more responder devices; or edited computer code.

5. The method of claim 1, wherein the initiator device is operated by one or more students, and the network of responder devices is operated by one or more of experts, mentors, or donors, whose credentials are recorded on a public blockchain, wherein the experts, mentors, or donors may transmit, by a network interface coupled to a data communication network, microtransactions to the one or more students to incentivize the one or more students to send high quality requests.

6. The method of claim 1, wherein the initiator device is operated by one or more of experts, mentors, or donors, whose credentials are recorded on a public blockchain, and the responder devices are one or more of students, experts, mentors or donors, whose credentials are recorded on a public blockchain, wherein the reward for responding, by a network interface coupled to a data communication network, to the request is a scholarship microtransaction, to which responder devices may transmit additional microtransactions to increase the reward.

7. The method of claim 1, wherein possession of a predetermined quantity of the digital currency may grant a device expanded rights to transmit and receive, by a network interface coupled to a data communication network, larger microtransactions based on a proof-of-stake blockchain configuration.

8. The method of claim 1, wherein the broadcast transaction query and plurality of responses are validated, using a processor, by one or more of a responder device or an algorithm in exchange for a microtransaction administered, using a network interface coupled to a data communication network, by one of a smart contract, a blockchain, or the broadcast transaction query.

9. An apparatus, comprising:
one or more transmitters, at least partially implemented in hardware, configured to transmit, by a network interface coupled to a data communication network, a broadcast transaction request from an initiator device to a network of responder devices to answer a query within a time limit in exchange for a reward of microtransactions of digital currency;
one or more receivers, at least partially implemented in hardware, configured to receive, by a network interface coupled to a data communication network, a plurality of responses to the broadcast transaction query;
one or more processors coupled to a memory configured to store the broadcast transaction query, the plurality of responses, and microtransactions of digital currency;
one or more processors coupled to a memory configured to record the broadcast transaction query, plurality of responses, and microtransactions in the memory, and record, by a network interface coupled to a data communication network, the broadcast transaction query, plurality of responses, and microtransactions in one or more blockchains.

10. The apparatus of claim 9, wherein the broadcast transaction query comprises one or more of a question to answer, a problem to solve, a reward offer for responding to the request, and a time limit.

11. The apparatus of claim 10, wherein the broadcast transaction query is in the form of one or more of text, digital images, audio files, a mathematical equation, a puzzle, a game, or computer code.

12. The apparatus of claim 9, wherein the plurality of responses is in the form of one or more of text, digital images, audio files, a final solution to a mathematical equation, a step-by-step solution to a mathematical equation, a solved puzzle, a game played, using a network interface coupled to a data communication network, between the initiator device and one or more responder devices; or edited computer code.

13. The apparatus of claim 9, wherein the initiator device is operated by one or more students, and the network of responder devices is operated by one or more of experts, mentors, or donors, whose credentials are recorded on a public blockchain, wherein the experts, mentors, or donors may transmit, by a network interface coupled to a data communication network, microtransactions to the one or more students to incentivize the one or more students to send high quality requests.

14. The apparatus of claim 9, wherein the initiator device is operated by one or more of experts, mentors, or donors, whose credentials are recorded on a public blockchain, and the responder devices are operated by one or more of students, experts, mentors or donors, whose credentials are recorded on a public blockchain, wherein the reward for responding to the request is a scholarship microtransaction, to which responder devices may transmit, by a network interface coupled to a data communication network, additional microtransactions to increase the reward.

15. The apparatus of claim 9, wherein possession of a predetermined quantity of the digital currency may grant a device expanded rights to transmit and receive, by a network interface coupled to a data communication network, larger microtransactions based on a proof-of-stake blockchain configuration.

16. The apparatus of claim 9, wherein the broadcast transaction query and plurality of responses are validated, with a processor, by one or more of a responder device or an algorithm in exchange for a microtransaction administered, using a network interface coupled to a data communication network, by one of a smart contract, a blockchain, or the broadcast transaction query.

17. A non-transitory computer readable storage medium configured to store, with a processor coupled to a memory, instructions that when executed causes a processor to perform:
transmitting, by a network interface coupled to a data communication network, a broadcast transaction request from an initiator device to a network of responder devices to answer a query within a time limit in exchange for a microtransaction reward of digital currency;
validating, with a processor, the broadcast transaction request in exchange for a microtransaction according to a blockchain proof-of-work configuration;
appending, with a processor, request validation data to the broadcast transaction request to create a package;
recording, with a processor coupled to a memory, package and microtransaction data on the plurality of responder devices;
responding, by a network interface coupled to a data communication network, to the broadcast transaction request with a plurality of responses from the network of responder devices;
appending, with a processor, the plurality of responses to the package;
validating, with a processor, the plurality of responses in exchange for a microtransaction according to a blockchain proof-of-work configuration;
appending, with a processor, response validation and microtransaction data to the package;
transmitting, by a network interface coupled to a data communication network, the package from the network of responder devices to the initiator device;
transmitting, by a network interface coupled to a data communication network, the package between the initiator device and the network of responder devices in subsequent iterations until the time limit expires;
determining, with a processor, one or more best responses from among the plurality of responses;
recording, with a processor coupled to a memory, package data and microtransactions on the initiator device;
transmitting, by a network interface coupled to a data communication network, the reward to the one or more responder devices that provided the one or more best responses;
combining, by a network interface coupled to a data communication network, data related to the request, request validation, plurality of responses, response validation, one or more best answers, and microtransactions into a block of data; and
recording, by a network interface coupled to a data communication network, the block of data on a blockchain.

18. The non-transitory computer readable storage medium of claim 17, wherein the processor is further configured to manifest the broadcast transaction query in the form of one or more of text, digital images, audio files, a mathematical equation, a puzzle, a game, or computer code.

19. The non-transitory computer readable storage medium of claim 17, wherein the processor is further configured to manifest responses to the broadcast transaction query in the form of one or more of text, digital images, audio files, a final solution to a mathematical equation, a step-by-step solution to a mathematical equation, a solved puzzle, a game played, using a network interface coupled to a data communication network, between the initiator device and one or more responder devices; or edited computer code.

20. The non-transitory computer readable storage medium of claim 17, wherein the processor is further configured to validate, with a processor, the broadcast transaction query and plurality of responses by one or more of human input or an algorithm in exchange for a microtransaction administered, using a network interface coupled to a data communication network, by one of a smart contract, a blockchain, or the broadcast transaction query.
